(19) United States
(12) Patent Application Publication
(10) Pub. No.: US 2025/0089113 A1
(43) Pub. Date: Mar. 13, 2025

(54) MAP COORDINATION FOR CHANNEL RESOURCE ANNOUNCEMENT FOR PEER-TO-PEER COMMUNICATION

(71) Applicant: Samsung Electronics Co., Ltd., Suwon-si (KR)

(72) Inventors: Rubayet Shafin, Allen, TX (US); Boon Loong Ng, Plano, TX (US); Vishnu Vardhan Ratnam, Plano, TX (US); Peshal Nayak, Plano, TX (US); Yue Qi, Plano, TX (US)

(21) Appl. No.: 18/814,396

(22) Filed: Aug. 23, 2024

Related U.S. Application Data
(60) Provisional application No. 63/538,010, filed on Sep. 12, 2023.

(51) Int. Cl. H04W 76/15; H04W 28/16; H04W 88/08

(52) U.S. Cl. CPC H04W 76/15; H04W 28/16; H04W 88/08

(57) ABSTRACT

A first access point (AP) device in a wireless network, the first STA device comprising a memory and a processor coupled to the memory, the processor configured to transmit, to a second AP, a first frame that requests multi-AP coordination (MAP) for peer-to-peer (P2P) communication amongst a plurality of stations (STAs) and includes information to coordinate allocation of resources for the STAs to use for the P2P communication, receive, from the second AP, a second frame that responds to the first frame, and advertise information on allocation of resources for the P2P communication to one or more STAs associated with the first AP.

### CROSS-REFERENCE TO RELATED APPLICATIONS

This application claims the benefit of priority from U.S. Provisional Application No. 63/538,010, entitled “MAP Coordination for Channel Resource Announcement for Peer-to-Peer Communication” filed Sep. 12, 2023, which is incorporated herein by reference in its entirety.

### TECHNICAL FIELD

This disclosure relates generally to a wireless communication system, and more particularly to, for example, but not limited to, multi-access point (MAP) coordination for channel resource announcement for peer-to-peer (P2P) communication.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first access point (AP) in a wireless network, the first AP comprising a memory, and a processor coupled to the memory. The processor is configured to transmit, to a second AP, a first frame that requests multi-AP coordination (MAP) for peer-to-peer (P2P) communication amongst a plurality of stations (STAs) and includes information to coordinate allocation of resources for one or more STAs to use for the P2P communication. The processor is configured to receive, from the second AP, a second frame that responds to the first frame. The processor is configured to advertise information on allocation of resources for the P2P communication to one or more STAs associated with the first AP.

In some embodiments, the information included in the first frame includes one or more channels or one or more time periods for the P2P communication.

In some embodiments, the second frame accepts the request for MAP coordination

In some embodiments, the second frame provides an alternative set of channels or time periods for the P2P communication amongst the plurality of STAs, where the processor is further configured to transmit, to the second AP, a third frame that requests MAP coordination and includes the alternative set of channels or time periods for the P2P communication amongst the plurality of STAs, receive, from the second AP, a fourth frame that accepts the request by the third frame, and advertise, to the one or more STAs associated with the first AP, the alternative set of channels or time periods for the P2P communication.

In some embodiments, the plurality of STAs are associated with the first AP and are in a first basic service set (BSS).

In some embodiments, a first STA in the plurality of STAs is associated with the first AP and a second STA in the plurality of STAs is associated with the second AP such that the first STA and the second STA are in different basic service sets (BSSs).

In some embodiments, the first frame includes information for target-wake-time (TWT) based coordination, time division multiple access (TDMA) based coordination, spatial reuse based MAP coordination, or coordination for channel announcement for P2P communication.

In some embodiments, the advertised information is advertised in a beacon frame or a probe response frame.

One aspect of the present disclosure provides a first access point (AP) in a wireless network. The first AP comprises a memory and a processor coupled to the memory. The processor is configured to receive, from a second AP, a first frame that requests multi-AP coordination (MAP) for peer-to-peer (P2P) communication amongst a plurality of stations (STAs) and includes information to coordinate allocation of resources for one or more STAs to use for the P2P communication. The processor is configured to transmit, to the second AP, a second frame that responds to the first frame. The processor is configured to advertise information on allocation of resources for the P2P communication to one or more STAs associated with the first AP.

In some embodiments, the information included in the first frame includes one or more channels or one or more time periods for the P2P communication.

In some embodiments, the second frame accepts the request for MAP coordination.

In some embodiments, the second frame provides an alternative set of channels and time periods for the P2P communication amongst the plurality of STAs, where the processor is further configured to receive, from the second AP, a third frame that requests MAP coordination and includes the alternative set of channels or time periods for the P2P communication amongst the plurality of STAs, transmit, to the second AP, a fourth frame that accepts the request by the third frame, and advertise, to the one or more STAs associated with the first AP, the alternative set of channels or time periods for the P2P communication.

In some embodiments, the plurality of STAs are associated with the first AP and are in a first basic service set (BSS).

In some embodiments, a first STA in the plurality of STAs is associated with the first AP and a second STA in the plurality of STAs is associated with the second AP such that the first STA and the second STA are in different basic service sets (BSSs).

In some embodiments, the first frame includes information for target-wake-time (TWT) based coordination, time division multiple access (TDMA) based coordination, spatial reuse based MAP coordination, or coordination for channel announcement for P2P communication.

In some embodiments, the advertised information is advertised in a beacon frame or a probe response frame.

One aspect of the present disclosure provides a computer-implemented method for multi-AP coordination (MAP) for peer-to-peer (P2P) communication at a first access point (AP) in a wireless network. The method comprises transmitting, to a second AP, a first frame that requests MAP coordination for P2P communication amongst a plurality of stations (STAs) and includes information to coordinate allocation of resources for one or more STAs to use for the P2P communication. The method comprises receiving, from the second AP, a second frame that responds to the first frame. The method comprises advertising information on allocation of resources for the P2P communication to one or more STAs associated with the first AP.

In some embodiments, the information included in the first frame includes one or more channels or one or more time periods for the P2P communication.

In some embodiments, the second frame accepts the request for MAP coordination.

In some embodiments, the second frame provides an alternative set of channels or time periods for the P2P communication amongst the plurality of STAs, where the method further comprises transmitting, to the second AP, a third frame that requests MAP coordination and includes the alternative set of channels or time periods for the P2P communication amongst the plurality of STAs, receiving, from the second AP, a fourth frame that accepts the request by the third frame, and advertising, to the one or more STAs associated with the first AP, the alternative set of channels or time periods for the P2P communication.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a network with different types of traffic in accordance with an embodiment.

FIG. 5 illustrates MAP coordination for channel announcement for P2P communication in accordance with an embodiment.

FIG. 6 illustrates MAP coordination for channel announcement for P2P communication in accordance with an embodiment.

FIG. 7 illustrates MAP coordination for channel resource guidance for P2P communication in accordance with an embodiment.

FIG. 8 illustrates a P2P channel and time period negotiation and advertisement in accordance with an embodiment.

FIG. 9 illustrates a flow chart of an example process of MAP coordination for P2P communication by an initiating AP in accordance with an embodiment.

FIG. 10 illustrates a flow chart of an example process for MAP coordination for P2P communication by a receiving AP in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

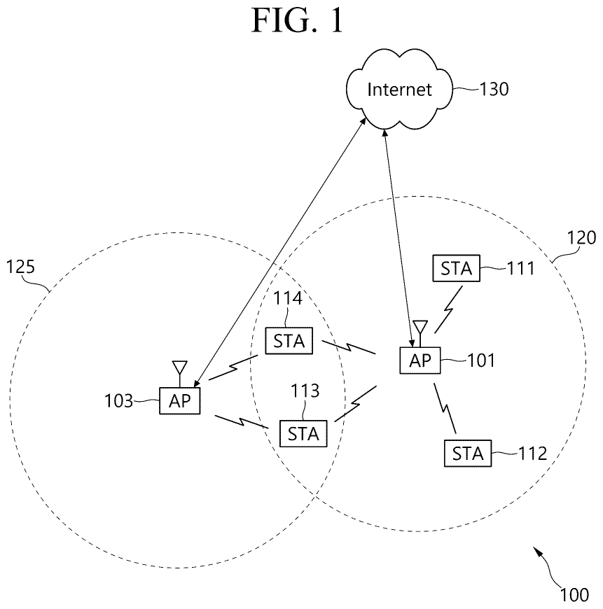

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

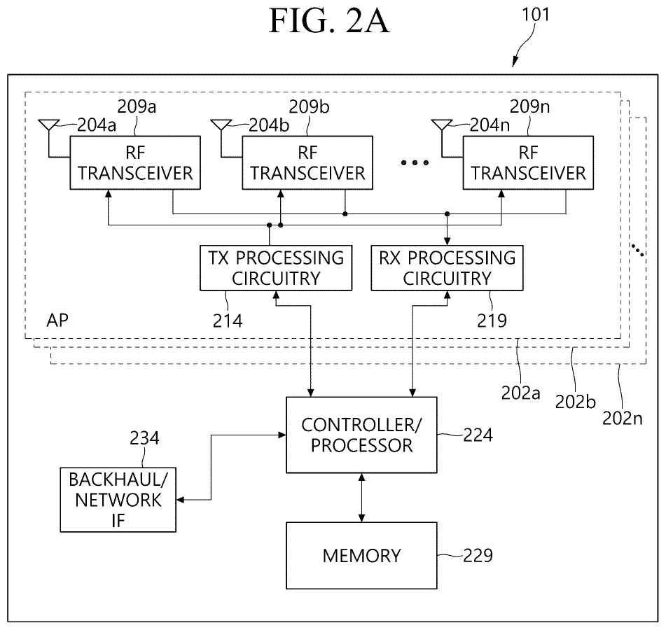

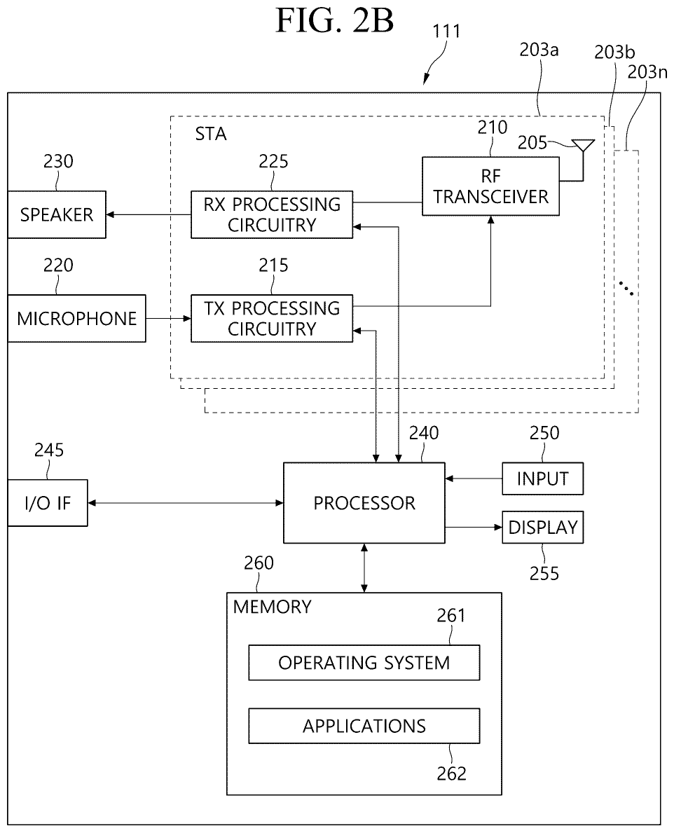

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

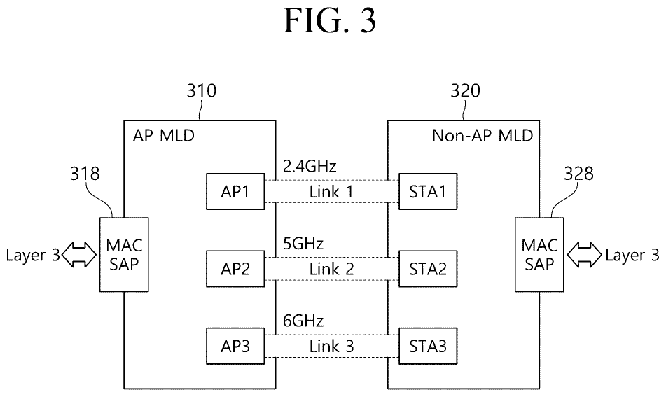

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

Next generation WLAN systems may benefit from providing better support for low-latency applications. In particular, it is not uncommon to observe numerous devices operating on a same network, where different devices have different latency requirements. Many of such devices may be latency-tolerant but may still contend with devices that have low-latency applications for the same time and frequency resources. In some cases, the access point (AP) as the network controller may not have enough control over the unregulated/unmanaged traffic that contend with the low-latency traffic within the infrastructure basic service set (BSS). Some of the unmanaged traffic that interfere with the AP's BSS' latency sensitive traffic may be coming from uplink (UL)/downlink (DL) or direct link communications within the infrastructure BSS that the AP manages. Other interference may be due to transmission in a neighboring infrastructure BSS (OBSS). Yet other interference may be coming from a neighboring independent BSS or P2P networks.

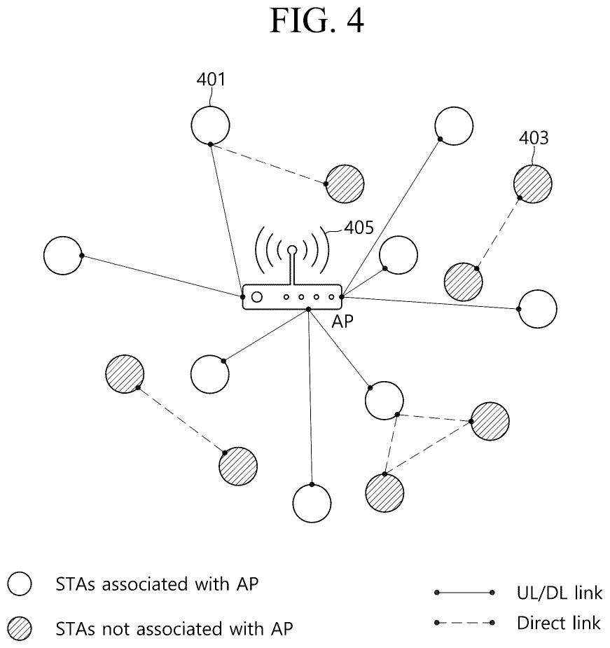

FIG. 4 illustrates a network with different types of traffic in accordance with an embodiment. In particular, FIG. 4 illustrates a network with an AP 405 and numerous STAs, where certain STAs, such as STA 401, are associated with the AP, as indicated by the key in the figure. Certain STAs, such as STA 403, are not associated with the AP. Furthermore, as indicated by the key, the STAs associated with the AP may have an UL/DL link with the AP, as illustrated by the solid lines connecting the STAs with the AP. Certain STAs may have a direct link with other STAs as indicated by the dashed lines.

WLAN systems in accordance with this disclosure may include various mechanisms that provide for better handling of the unmanaged traffic in order to prioritize the low-latency traffic in the network.

In some embodiments, a STA can receive guidance from the associated AP on which channels the STA should operate its P2P communications. However, there can be interference from the OBSS that may disrupt the P2P communication between two peer STAs. Such interference may need to be handled so that the peer STAs can satisfy their QoS requirements for P2P communication.

In some embodiments, a first AP can coordinate with a second AP to determine a common set of time periods that can be used by peer STAs for their P2P communication. For example, a set of time periods that can be used by the P2P STAs in the two BSSs operated by the two APs. These time periods can be regarded as more conducive for P2P communication. For example, both the APs can reduce infrastructure BSS activities during these time periods. In some embodiments, multi-AP (MAP) coordination for channel announcement can be utilized for P2P communication with reduced interference from the OBSS.

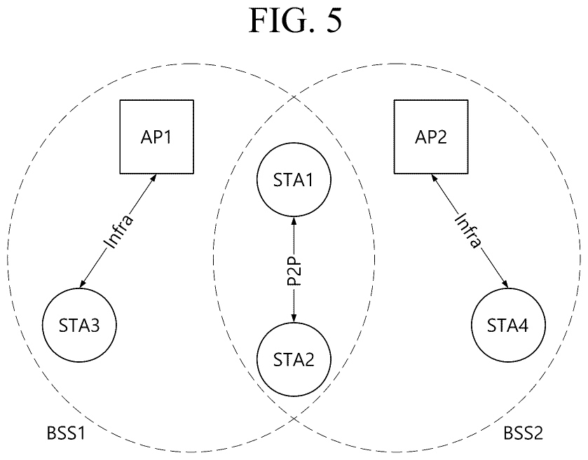

FIG. 5 illustrates MAP coordination for channel announcement for P2P communication in accordance with an embodiment. In particular, FIG. 5 illustrates a first BSS, BSS1, managed by a first AP, AP1, and a second BSS, BSS2, managed by a second AP, AP2. AP1 is associated with and has an infrastructure connection with STA3 and AP2 is associated with and has an infrastructure connection with STA4. Furthermore, STA1 and STA2 are P2P STAs and are associated with the same AP, AP1. STA1 and STA2 may be following the channel/transmission window recommended by the AP1 in BSS1 for their P2P communication. However, the P2P link may be suffering from the interference from the OBSS, BSS2. As illustrated, there may be interference between BSS1 and BSS2, as illustrated by the overlapping circles illustrating the overlapping ranges of the wireless networks. Accordingly, AP1 can request the OBSS AP2 to limit its transmission to a specific channel that AP1 specifies for P2P communication. In some embodiments, MAP coordination for channel announcement may be utilized for P2P communication between two peer STAs where the peer STAs are associated with two different APs.

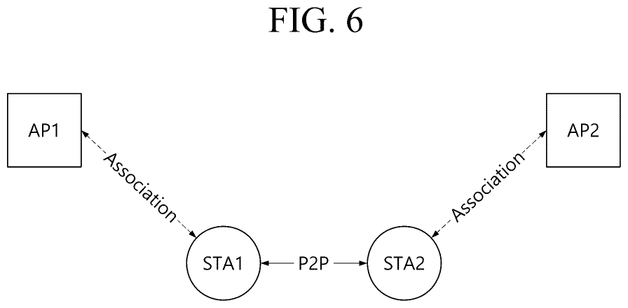

FIG. 6 illustrates MAP coordination for channel announcement for P2P communication between two peer STAs where the peer STAs are associated with two different APs in accordance with an embodiment. As illustrated, a first AP, AP1, is associated with STA1 and a second AP, AP2 is associated with STA2. Furthermore, STA1 and STA2 may be P2P STAs. Accordingly, when associated with two different APs, it may be helpful to manage the infrastructure and P2P communications by providing an advertisement from the APs to the STAs, where the advertisement may provide some guidance on the channel and time usage for the P2P network. As such, both AP1 and AP2 may need to come up with a common channel that they dedicate for P2P communications.

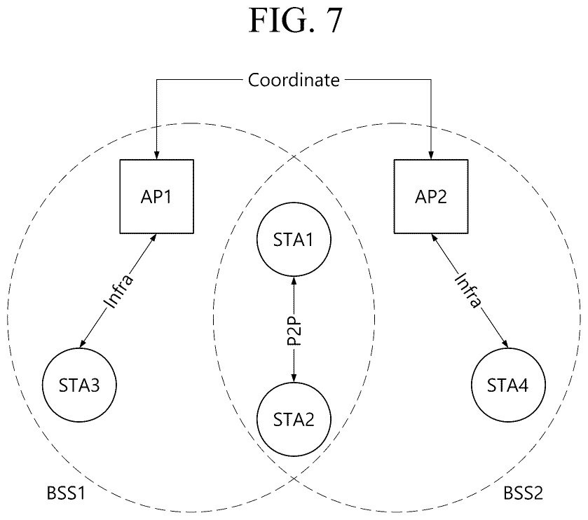

FIG. 7 illustrates MAP coordination for channel resource guidance for P2P in accordance with an embodiment. As illustrated in FIG. 7, a first AP, AP1 may manage a first BSS, BSS1, and a second AP, AP2, may manage a second BSS, BSS2. BSS1 includes STA1, which is associated with AP1 and has an infrastructure connection with AP1. BSS2 includes STA4 which is associated with AP2 and has an infrastructure connection with AP2. Furthermore, STA1 and STA2 may be P2P STAs. In FIG. 7, AP1 and AP2 may coordinate (e.g., exchange frames) to determine a common set of channels and/or time periods that can be utilized by the P2P communication in these two BSSs.

In some embodiments, a first AP can send a P2P channel negotiation request frame to a second AP. This request frame may include one or more channels and/or time periods that may be preferable by the first AP for P2P communication among P2P STAs. A second AP, upon receiving the request frame, can send a P2P Channel Negotiation Response frame to the first AP. The response frame may accept the request or may suggest an alternative set of channel and/or time periods for P2P communication among P2P STAs. In particular, the second AP may send a response frame without accepting the request and the first AP can send another request frame, where the request frame may include the parameters suggested in the response frame. The second AP may then send a second response frame accepting the request with the alternative set of parameters. Upon reception of the second response frame by the first AP, both the first AP and the second AP may advertise the channel and time periods that have been agreed upon. In some embodiments, the advertisements of the channel and time periods can be made in an AP's respective Beacon frames or Probe Response frames. Furthermore, the channel information may provide an indication that these channel resources may be more conducive for P2P communication among P2P STAs for their P2P communication.

In some embodiments, a channel negotiation request frame and a channel negotiation request response frame may include a Channel Usage element and a TWT element to indicate the conducive channels and time period schedule for P2P communication.

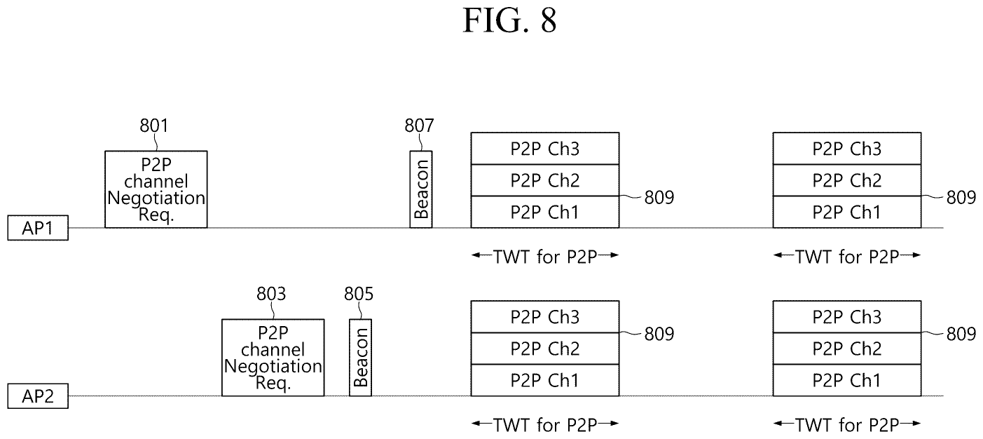

FIG. 8 illustrates a P2P channel and time period negotiation and advertisement in accordance with an embodiment. As illustrated, AP1 can transmit a P2P channel negotiation request frame 801 to AP2. AP2 can transmit a channel negotiation response frame 803 to AP1. AP2 can transmit a beacon frame 805, which may advertise the channels and/or time periods that were agreed upon between AP1 and AP2. Likewise, AP1 can transmit a beacon frame 807 that may advertise the channels and/or time periods agreed upon with AP2. Accordingly, during the TWT for the P2P 809, a set of channels may be utilized, as illustrated including P2P Ch. 3, P2P CH. 2, and P2P Ch. 1.

Table 1 below provides a possible format of a P2P Channel Negotiation Request frame in accordance with an embodiment.

TABLE 1

| Order | Information |
|---|---|
| 1 | Category |
| 2 | Unprotected S1G Action |
| 3 | Dialog Token |
| 4 | Multi-AP (MAP) Coordination Mode |
| 5 | MAP Capabilities Information |
| 6 | WNM Action |
| 7 | Channel Usage Elements |
| 8 | Supported Operating Classes Element |
| 9 | TWT Elements |
| 10 | Timeout Interval Element |
| 11 | HT Capabilities Element |
| 12 | VHT Capabilities Element |
| 13 | HE Capabilities Element |
| 14 | HE 6 GHz Capabilities Element |

As provided in Table 1, the category filed may provide category information of the frame. The unprotected S1G protected action field may differentiate the unprotected S1G action frame formats. The dialog token field may identify the request.

The Multi-AP (MAP) Coordination Mode field may indicate the type of MAP coordination that is intended by this request frame. For example, this field can indicate whether the MAP coordination is for TWT based coordination, TDMA based coordination, Spatial Reuse based MAP coordination, or coordination for channel announcement for P2P communication.

The MAP Capabilities Information field may include information related to its different capabilities feature pertaining to MAP coordination and may share this information with the recipient of the frame.

The wireless network management (WNM) action field may include information for managing the network and may be used to indicate different action values. The channel usage elements field may provide usage information for one or more channels. The supported operating classes element field may provide operating class information. The target wake time (TWT) elements field may include information to establish and manage TWT agreements. The timeout interval element field may include information regarding a timeout interval. The high throughput (HT) capabilities element field may provide information regarding HT capabilities of the STA. The very high throughput (VHT) capabilities element field may provide information regarding VHT capabilities of the STA. The high efficiency (HE) capabilities element field may provide information regarding HE capabilities of the STA. The high efficiency (HE) 6 GHZ capability element field may provide information regarding HE 6 GHZ capabilities of the STA.

Table 2 below provides a possible format of a P2P Channel Negotiation Response frame in accordance with an embodiment.

TABLE 2

| Order | Information |
|---|---|
| 1 | Category |
| 2 | Unprotected S1G Action |
| 3 | Dialog Token |
| 4 | Multi-AP (MAP) C-OCP Coordination Mode |
| 5 | MAP Capabilities Information |
| 6 | WNM Action |
| 7 | Channel Usage Elements |
| 8 | Supported Operating Classes Element |
| 9 | TWT Elements |
| 10 | Timeout Interval Element |
| 11 | HT Capabilities Element |
| 12 | VHT Capabilities Element |
| 13 | HE Capabilities Element |
| 14 | HE 6 GHz Capabilities Element |
| 15 | Status Code |

In Table 2, the category filed may provide category information of the frame. The unprotected SIG protected action field may differentiate the unprotected SIG action frame formats. The dialog token field may identify the request. The Multi-AP (MAP) C-OCP Coordination Mode field may indicate the type of MAP coordination that is intended by this response frame. For example, this field can indicate whether the MAP coordination is for TWT based coordination, TDMA based coordination, Spatial Reuse based MAP coordination, or coordination for channel announcement for P2P communication.

The MAP Capabilities Information field may include information related to its different capabilities feature pertaining to MAP coordination and may share this information with the recipient of the frame.

The wireless network management (WNM) action field may include information for managing the network and may be used to indicate different action values. The channel usage elements field may provide usage information for one or more channels. The supported operating classes element field may provide operating class information. The target wake time (TWT) elements field may include information to establish and manage TWT agreements. The timeout interval element field may include information regarding a timeout interval. The high throughput (HT) capabilities element field may provide information regarding HT capabilities of the STA. The very high throughput (VHT) capabilities element field may provide information regarding VHT capabilities of the STA. The high efficiency (HE) capabilities element field may provide information regarding HE capabilities of the STA. The high efficiency (HE) 6 GHZ capability element field may provide information regarding HE 6 GHZ capabilities of the STA.

The Status code field may include the outcome in response to the request frame received from another AP. If the Status Code is set to a value ACCEPT, then it may indicate that the AP sending the response frame has accepted the channel announcement parameter from another AP. If the Status Code is set to a value REJECT, then it may indicate that the AP sending the response frame has rejected the channel announcement parameter from another AP. If the Status Code is set to a value ALTERNATE, then it may indicate that the AP sending the response frame suggests an alternative set of parameters for MAP coordination with the AP that sent the request frame.

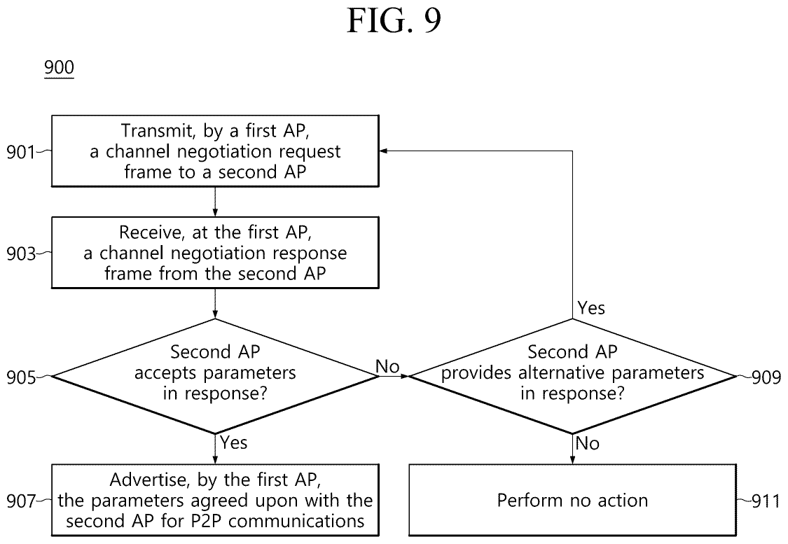

FIG. 9 illustrates a flow chart of an example process of MAP coordination for P2P communication by an initiating AP in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed in an AP, such as the AP illustrated in FIG. 7.

The process 900, in operation 901, a first AP transmits a channel negotiation request frame to a second AP. In some embodiments, the channel negotiation request frame can provide one or more parameters for P2P communications by peer STAs. In some embodiments, the peer STAs may be associated with a same AP. In certain embodiments, the peer STAs may be associated with different APs. The parameters may include one or more channels that can be used for communications by the peer STAs. In some embodiments, the parameters may include one or more time periods during which peer STAs may communicate.

In operation 903, the first AP receives a channel negotiation response frame from the second AP. In some embodiments, the channel negotiation response frame may accept the request, reject the request, or may suggest an alternative set of parameters for P2P communications. In some embodiments, the channel negotiation request frame and the channel negotiation response frame may include a channel usage element and a TWT element to indicate the conducive channels and/or time period schedule for P2P communication.

In operation 905, the first AP determines if the second AP accepts the parameters specified in the request. If in operation 905, the second AP accepts, then the process proceeds to operation 907 where the first AP advertises the parameters agreed upon with the second AP for P2P communication. In some embodiments, the first AP may advertise the parameters, including the channel and/or time periods agreed upon, in beacon frames or probe response frames.

In operation 905, if the second AP does not accept the request, then the process proceeds to operation 909 where the first AP determines if the second AP provides an alternative set of parameters.

If in operation 909, the first AP determines that the second AP has provided an alternative set of parameters, then the process goes back to operation 901 to continue the negotiation. In particular, if the response frame includes an alternative set of parameters and the first AP agrees to these alternative parameters, then the first AP may transmit another channel negotiation request frame that includes the alternative set of parameters to the second AP.

If in operation 909, the second AP has not provided an alternative set of parameters, but rather rejected the request, then in operation 911 the first AP performs no action.

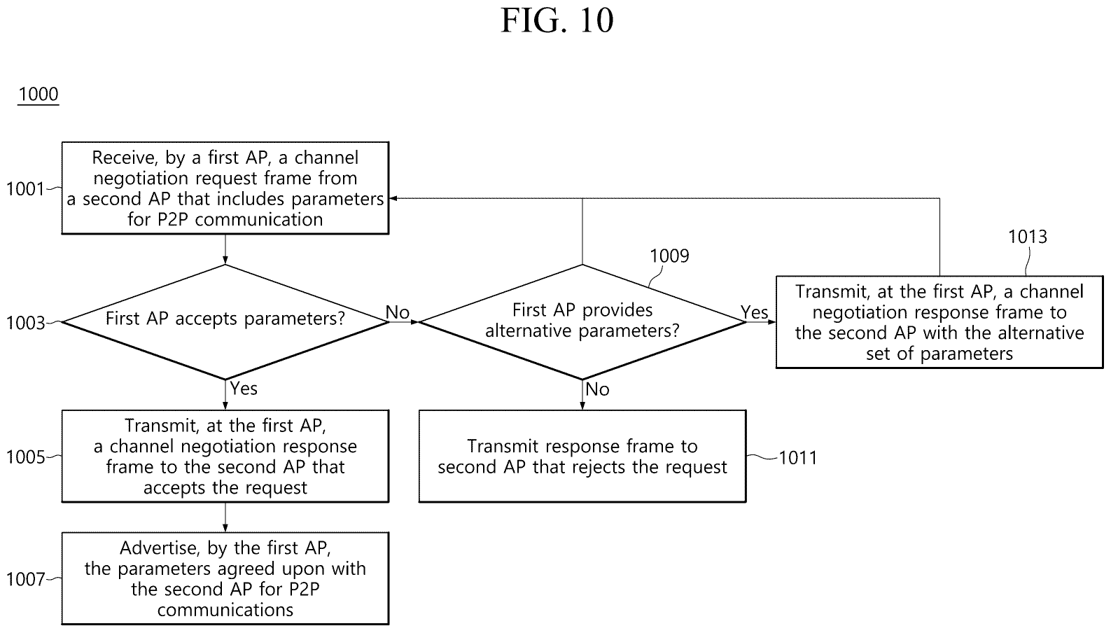

FIG. 10 illustrates a flow chart of an example process for MAP coordination for P2P communication by a receiving AP in accordance with an embodiment. Although one or more operations are described or shown in particular sequential order, in other embodiments the operations may be rearranged in a different order, which may include performance of multiple operations in at least partially overlapping time periods. The flowchart depicted in FIG. 9 illustrates operations performed in an AP, such as the AP illustrated in FIG. 7.

The process 1000, in operation 1001, the first AP receives a channel negotiation request frame from a second AP. In some embodiments, the channel negotiation request frame can provide one or more parameters for P2P communications by peer STAs. The parameters may include one or more channels that can be used for communications by the peer STAs. In some embodiments, the parameters may include one or more time periods during which peer STAs may communicate.

In operation 1003, the first AP determines whether it accepts the parameters in the request frame. If in operation 1003, the first AP accepts the parameters, then the process proceeds to operation 1005 where the first AP transmits a channel negotiation response frame to the second AP that accepts the request. In some embodiments, the channel negotiation request frame and the channel negotiation response frame may include a channel usage element and a TWT element to indicate the conducive channels and/or time period schedule for P2P communication.

In operation 1007, the first AP advertises the parameters agreed upon with the second AP for P2P communication. In some embodiments, the first AP may advertise the parameters, including the channel and/or time periods agreed upon, in beacon frames or probe response frames.

If in operation 1003, the first AP does not accept the parameters, then the process proceeds to operation 1009 where the first AP determines whether it wants to provide an alternative set of parameters for the P2P communication. If in operation 1009 the first AP determines that it wants to provide an alternative set of parameters, then the process proceeds to operation 1013, where the first AP transmits a channel negotiation response frame to the second AP that includes the alternative set of parameters and the process returns to operation 1001.

If in operation 1009, the first AP determines it does not want to provide an alternative set of parameters (i.e., the first AP rejects the request), then the process proceeds to operation 1011 where the first AP transmits a channel negotiation response frame that rejects the request.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) in a wireless network, the first AP comprising:
a memory;
a processor coupled to the memory, the processor configured to:
transmit, to a second AP, a first frame that requests multi-AP coordination (MAP) for peer-to-peer (P2P) communication amongst a plurality of stations (STAs) and includes information to coordinate allocation of resources for one or more STAs to use for the P2P communication;
receive, from the second AP, a second frame that responds to the first frame; and
advertise information on allocation of resources for the P2P communication to one or more STAs associated with the first AP.

2. The first AP of claim 1, wherein the information included in the first frame includes one or more channels or one or more time periods for the P2P communication.

3. The first AP of claim 2, wherein the second frame accepts the request for MAP coordination.

4. The first AP of claim 2, wherein the second frame provides an alternative set of channels or time periods for the P2P communication amongst the plurality of STAs, wherein the processor is further configured to:
transmit, to the second AP, a third frame that requests MAP coordination and includes the alternative set of channels or time periods for the P2P communication amongst the plurality of STAs;
receive, from the second AP, a fourth frame that accepts the request by the third frame; and
advertise, to the one or more STAs associated with the first AP, the alternative set of channels or time periods for the P2P communication.

5. The first AP of claim 1, wherein the plurality of STAs are associated with the first AP and are in a first basic service set (BSS).

6. The first AP of claim 1, wherein a first STA in the plurality of STAs is associated with the first AP and a second STA in the plurality of STAs is associated with the second AP such that the first STA and the second STA are in different basic service sets (BSSs).

7. The first AP of claim 1, wherein the first frame includes information for target-wake-time (TWT) based coordination, time division multiple access (TDMA) based coordination, spatial reuse based MAP coordination, or coordination for channel announcement for P2P communication.

8. The first AP of claim 1, wherein the advertised information is advertised in a beacon frame or a probe response frame.

9. A first access point (AP) in a wireless network, the first AP comprising:
a memory;
a processor coupled to the memory, the processor configured to:
receive, from a second AP, a first frame that requests multi-AP coordination (MAP) for peer-to-peer (P2P) communication amongst a plurality of stations (STAs) and includes information to coordinate allocation of resources for one or more STAs to use for the P2P communication;
transmit, to the second AP, a second frame that responds to the first frame; and
advertise information on allocation of resources for the P2P communication to one or more STAs associated with the first AP.

10. The first AP of claim 9, wherein the information included in the first frame includes one or more channels or one or more time periods for the P2P communication.

11. The first AP of claim 10, wherein the second frame accepts the request for MAP coordination.

12. The first AP of claim 10, wherein the second frame provides an alternative set of channels and time periods for the P2P communication amongst the plurality of STAs, wherein the processor is further configured to:
receive, from the second AP, a third frame that requests MAP coordination and includes the alternative set of channels or time periods for the P2P communication amongst the plurality of STAs;
transmit, to the second AP, a fourth frame that accepts the request by the third frame; and
advertise, to the one or more STAs associated with the first AP, the alternative set of channels or time periods for the P2P communication.

13. The first AP of claim 9, wherein the plurality of STAs are associated with the first AP and are in a first basic service set (BSS).

14. The first AP of claim 9, wherein a first STA in the plurality of STAs is associated with the first AP and a second STA in the plurality of STAs is associated with the second AP such that the first STA and the second STA are in different basic service sets (BSSs).

15. The first AP of claim 9, wherein the first frame includes information for target-wake-time (TWT) based coordination, time division multiple access (TDMA) based coordination, spatial reuse based MAP coordination, or coordination for channel announcement for P2P communication.

16. The first AP of claim 9, wherein the advertised information is advertised in a beacon frame or a probe response frame.

17. A computer-implemented method for multi-AP coordination (MAP) for peer-to-peer (P2P) communication at a first access point (AP) in a wireless network, the method comprising:
transmitting, to a second AP, a first frame that requests MAP coordination for P2P communication amongst a plurality of stations (STAs) and includes information to coordinate allocation of resources for one or more STAs to use for the P2P communication;
receiving, from the second AP, a second frame that responds to the first frame; and
advertising information on allocation of resources for the P2P communication to one or more STAs associated with the first AP.

18. The computer-implemented method of claim 17, wherein the information included in the first frame includes one or more channels or one or more time periods for the P2P communication.

19. The computer-implemented method of claim 18, wherein the second frame accepts the request for MAP coordination.

20. The computer-implemented method of claim 18, wherein the second frame provides an alternative set of channels or time periods for the P2P communication amongst the plurality of STAs, wherein the method further comprises:
transmitting, to the second AP, a third frame that requests MAP coordination and includes the alternative set of channels or time periods for the P2P communication amongst the plurality of STAs;
receiving, from the second AP, a fourth frame that accepts the request by the third frame; and
advertising, to the one or more STAs associated with the first AP, the alternative set of channels or time periods for the P2P communication.
